(19) United States
(12) Patent Application Publication
(10) Pub. No.: US 2007/0214429 A1
(43) Pub. Date: Sep. 13, 2007

(54) System and method for managing application alerts

(76) Inventors: Olga Lyudovyk, Austin, TX (US); Javier L. Jimenez, Austin, TX (US)

Correspondence Address: HAMILTON & TERRILE, LLP, P.O. BOX 203518, AUSTIN, TX, 78720, US

(21) Appl. No.: 11/374,444

(22) Filed: Mar. 13, 2006

(51) Int. Cl. G06F 9/00

(52) U.S. Cl. 715/772

(57) ABSTRACT

An alert queue module reduces presentation of alerts generated by applications running on an information handling system, such as system tray alerts, for selective subsequent viewing by an end user. For instance, inactive applications that are operating but not in focus at an information handling system display have their alerts suppressed unless the applications are on a white list of applications approved for presenting alerts. An icon presented at the display indicates that alerts have been suppressed and is selectable by an end user to present a list of suppressed alerts.

### BACKGROUND OF THE INVENTION

1. Field of the Invention

The present invention relates in general to the field of information handling system application alerts, and more particularly to a system and method for managing alerts presented by an application running on an information handling system.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have steadily improved in their capabilities as hardware components used to build systems have come to handle greater amounts of information in a more rapid manner. Application programmers who design and write applications to run on information handling systems have leveraged these improved capabilities to build ever more powerful and complex applications. Indeed, a typical information handling system multi-tasks by running multiple applications simultaneously. In a WINDOWS operating system environment, each application typically interfaces with an end user through its own window. The window of an application that is being actively used is displayed imposed over the windows of other applications that are operational but not currently selected for interaction by the end user. Operational applications may also be minimized to show an icon in a task bar typically active at the bottom of the display. When an end user launches an application, the WINDOWS operating system supports a window for the application by having the application call the CreateWindow API to create a window instance and return a window handle. The application uses the handle to customize the window if needed and applies parameters of the handle to invoke a ShowWindow API, which renders the window for presentation at the display. Other operating systems use similar mechanisms to present windows for multiple operational applications at a display and to allow an end user to selectively interact with an active application.

One difficulty faced by application programmers is that end users sometimes suffer information overload when multiple applications are simultaneously operational. As an aid for end users to manage active tasks, the WINDOWS operating system presents a notification area on the right side of the task bar with time and date information, icons for shortcuts to certain tasks, such as to use a microphone or speakers, and icons for activities of certain applications, such as a printing icon during printer operations and a mail icon for notification of receipt of a new e-mail. Since the relatively small area of the display represented by the notification area does not tend to immediately grab an end user's attention, applications have started to emphasize alerts in the notification area by presenting system tray alerts, also known as “toaster popups,” so called because these notifications sometimes appear as bread popping out of a toaster from the notification tray area. As an increasing number of applications have resorted to system tray alerts, overwhelmed end users sometimes become annoyed and, in fact, only find a handful of the alerts to have important information or to require end user action. Although individual applications typically provide end users with control over whether to present the alerts from the application, end users are still annoyed by setting the configurations of individual applications. Further, suppressing or turning off alerts may result in the end user missing some information of importance.

### SUMMARY OF THE INVENTION

Therefore a need has arisen for a system and method which manages alerts presented by applications running on an information handling system.

In accordance with the present invention, a system and method are provided which substantially reduce the disadvantages and problems associated with previous methods and systems for managing alerts presented by applications running on an information handling system. Windows created for presentation at an information handling system display are selectively suppressed from presentation based on predetermined parameters, such as the status of the application creating the window. Suppressed windows are queued for subsequent selection and presentation at the display, such as by activation of an icon at the display that is presented to indicate queuing of the suppressed windows.

More specifically, an alert queue module interfaces with an information handling system operating system to manage the creating and showing of windows by applications running on the information handling system. The alert queue module detects system tray alerts and selectively suppresses or presents the alerts based on predetermined parameters. For instance, the alert queue module detects creation of a window by an application and places the window in a blocked list if the application is inactive, such as not in focus at the display, unless the application is included in a white list of applications approved to present windows when in an operational but inactive state. Suppression of windows is indicated with an icon on the display that, upon activation, presents a queued list of the suppressed windows. An end user can thus select a window for presentation at a convenient time subsequent to the creation of the window, thereby having system tray alerts available for viewing.

The present invention provides a number of important technical advantages. One example of an important technical advantage is that an information handling system end user has a common interface to manage alerts from a variety of operational applications. Windows generated by an active application are automatically displayed to avoid interference with desired end user functions while alerts generated by predetermined operational but inactive applications are selectively queued for subsequent review by the end user. Queuing alerts for subsequent review avoids annoying end user disruptions while ensuring that relevant information remains available for end user consideration at a more convenient time.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for managing presentation of application system tray alerts at an information handling system display;

FIG. 2 depicts a graphical user interface that manages presentation of application system tray alerts at an information handling system; and

FIG. 3 depicts a flow diagram of a process for managing presentation of application system tray alerts at an information handling system.

### DETAILED DESCRIPTION

An alert queue module manages the presentation of system tray alerts by a variety of applications running on an information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

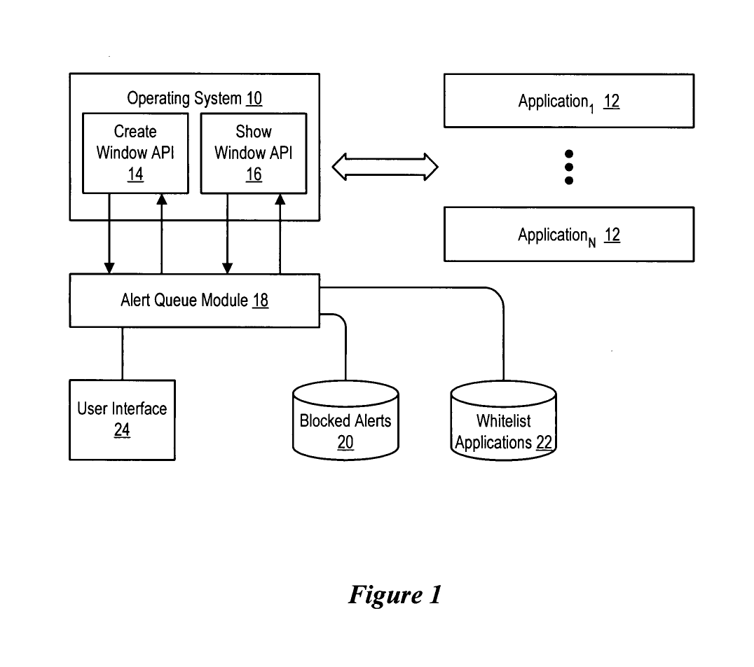

Referring now to FIG. 1, a block diagram depicts a system for managing presentation of application system tray alerts at an information handling system display. An operating system 10 running on the information handling systems coordinates the operations of physical processing components and supports the running of applications 12. Applications 12 present information at a display of the information handling system by calling a create window API 14 of operating system 10 to create a window instance. Create window API 14 returns a window handle to the requesting application 12 which uses the handle to customize the window and then to invoke a show window API 16. Show window API 16 renders the window with content of the application for presentation at a display device associated with the information handling system.

An alert queue module 18 running on the information handling system monitors the creation of windows by applications 12, such as by intercepting calls to create window API 14. Alert queue module 18 analyzes the created window to determine whether to allow or suppress the presentation of the window at the display. If alert queue module 18 determines to suppress presentation of the created window, the handle for the created window is stored in a blocked alerts list 20 and the window creation is allowed to complete. For instance, the created window is added to blocked alerts list 20 if the application 12 that called create window API 14 is in an inactive state that indicates that the request to show the window likely did not originate with an end user action. As an example, an application 12 is determined to be in an inactive state if none of the windows existing for the application 12 are in focus at the display. As an exception, windows created by inactive applications 12 are not added to blocked alert list 20 if the application that created the window is included in white list applications 22. Thus, for instance, firewall or security applications that perform desired functions even when inactive will have those functions presented at the display when in an inactive but operational state.

Alert queue module 18 applies blocked alerts list 20 to determine whether to allow calls by applications 12 to show window API 16 to present a requested window or suppress the requested window. If the window handle used to request show window API 16 is not on blocked alerts list 20, show window API 16 is allowed to run normally to render the window for presentation at a display of the information handling system. If the window handle used to request show window API 16 is on blocked alerts list 20, the presentation of the window is suppressed. A user interface 24 of alert queue module 18 provides end users with access to blocked alerts 20 as well as to white list applications 22. To present a suppressed window, user interface 24 selects the window handle of the desired window and alert queue module 18 allows show window API 16 to render the window. To alter the applications that have windows blocked, user interface 24 adds or deletes the applications from white list 22.

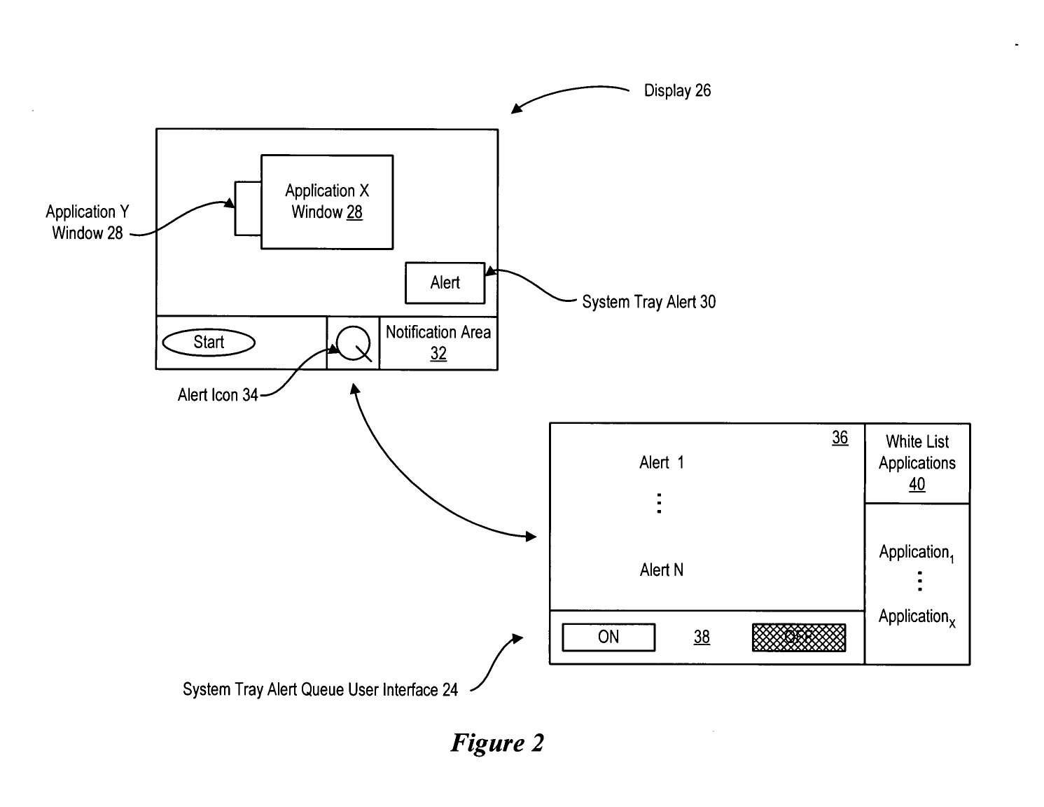

Referring now to FIG. 2, a graphical user interface 24 is depicted that manages presentation of application system tray alerts at an information handling system display 26. During normal operations, display 26 presents information generated by applications in windows 28 associated with each application. Generally, the application currently in use by the end user is presented with a window in focus over windows of other applications, such as the window of application x over the window of application y in FIG. 2. System tray alerts 30 are generated to pop up from notification area 32 to provide information to the end user. Modal system tray alerts, also known as dialog alerts, require interaction from the end user, in some instances precluding functions of certain applications until the dialog occurs. When the application that creates a system tray alert 30 is not in focus at display 26 and not on the white list of applications, alert queue module 18 suppresses the alert by preventing the show window API from rendering a window for display. Upon suppression of a window, an alert icon 34 is presented proximate the notification area 32 at the base of display 26. Activation of alert icon 34 presents system tray alert queue user interface 24 at display 26. User interface 24 lists the suppressed windows in an alert area 36 and on/off icons 38 to activate or deactivate suppression of windows by alert queue module 18. Selection of an alert from alert area 36 calls show window API 16 with the stored window handle to present the alert as originally created by its application. A white list applications area 40 lists applications that will not have alerts suppressed and allows the end user to add or remove applications from the white list.

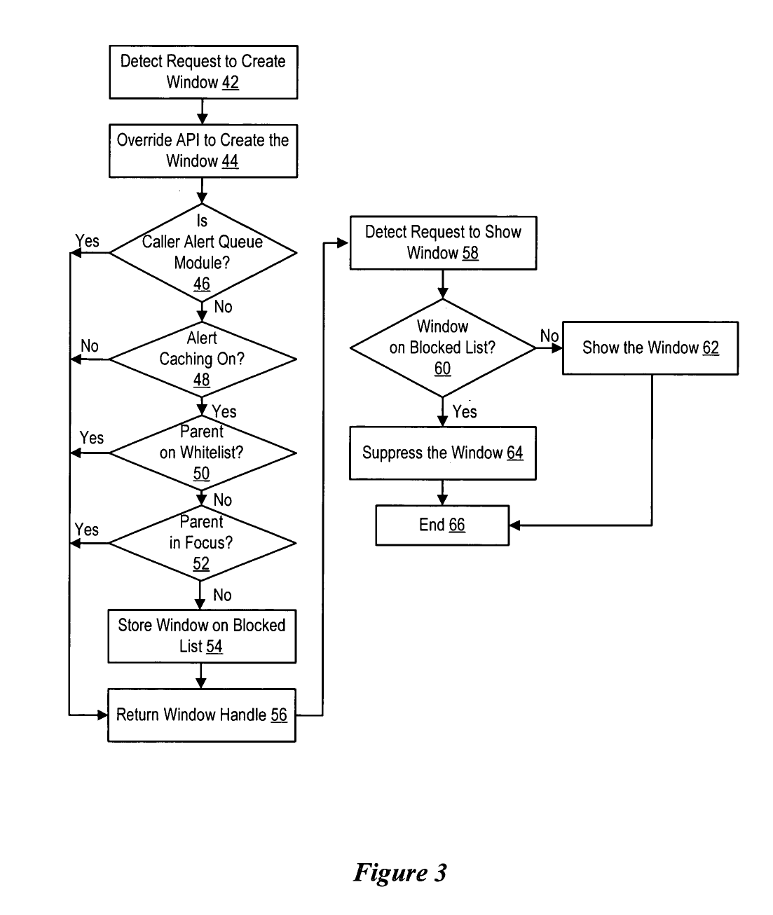

Referring now to FIG. 3, a flow diagram depicts a process for managing presentation of application system tray alerts at an information handling system. The process begins at step 42 with detection of a request to create a window by an application. At step 44, the API to create the window is overridden to first allow a determination of whether the alert should be presented or suppressed. At step 46, a determination is made whether a request to create the window came from the alert queue module itself and, if so, the process continues to step 56 so that the window will not be suppressed. If the request to create the window did not come from the alert queue module, the process continues to step 48 to determine if alert caching is on. If caching is not on, the process continues to step 56 so that the window will not be suppressed. If caching is on, the process continues to step 50 to compare the parent application that requested the window creation with the white list of applications that do not have windows suppressed. If the parent application is on the white list, the process continues to step 56 to allow presentation of the window. If the parent application is not on the white list, the process continues to step 52 to determine if the parent application is in focus at the display. If the parent application is not in focus, the process continues to step 54 to place the window on a blocked list before returning the window handle at step 56. If at step 52 the parent application is in focus, the process continues to step 56 to return the window handle so that the window is not suppressed. The process then continues to step 58 to detect a request to show the window. At step 60, a determination is made of whether the show window request relates to a window on the blocked list. If the window is not on the blocked list, the process continues to step 62 to show the window and ends at step 66. If the window is on the blocked list, the process continues to step 64 to suppress the window and ends at step 66.

Although the present invention has been described in detail, it should be understood that various changes, substitutions and alterations can be made hereto without departing from the spirit and scope of the invention as defined by the appended claims.

What is claimed is:

1. A system for managing application alerts presented at an information handling system display, the system comprising:
an operating system having a create API to create windows for applications and a show API to show the created windows at the display; and
an alert queue module interfaced with the operating system, the alert queue module operable to detect creation of a window for an application, to determine that the window is associated with an inactive application, and to selectively suppress the window associated with the inactive application based on one or more predetermined parameters.

2. The system of claim 1 wherein the inactive application comprises an operational application not in focus at the display.

3. The system of claim 2 wherein the predetermined parameters comprise an application white list, the alert queue module presenting windows associated with applications of the application white list.

4. The system of claim 1 wherein the alert queue module is further operable to store suppressed windows for subsequent presentation.

5. The system of claim 4 further comprising a user interface associated with the alert queue module and operable to present the suppressed windows in response to a user request.

6. The system of claim 4 wherein the alert queue module further comprises a notice icon presented at the display to indicate a suppressed window.

7. The system of claim 1 wherein the suppressed window comprises a system tray alert.

8. A method for managing application alerts presented at an information handling system display, the method comprising:
detecting creation of a window for an application;
determining that the application associated with the window is an inactive application; and
selectively suppressing the window associated with the application based on one or more predetermined conditions.

9. The method of claim 8 wherein determining that the application associated with the window is an inactive application further comprises determining that the application is not in focus.

10. The method of claim 8 wherein the window comprises a system tray alert.

11. The method of claim 10 wherein selectively suppressing the window further comprises:
comparing the application associated with the window to a white list of applications;
presenting the window if the application is on the white list of applications; and
suppressing the window if the application is not on the white list of applications.

12. The method of claim 8 further comprising:
storing the suppressed window at the information handling system; and
presenting the suppressed window at the information handling system display in response to a user request.

13. The method of claim 12 further comprising:
presenting a notification icon at the display to indicate storing of the suppressed window.

14. The method of claim 13 further comprising:
highlighting the notification icon to indicate a predetermined type of suppressed window.

15. The method of claim 14 wherein the predetermined type of suppressed window comprises a modal alert window.

16. A graphical user interface comprising:
plural windows, each window associated with one of plural applications, one or more of the applications operable to present system tray alerts;
an icon indicating suppression of one or more system tray alerts from presentation; and
a system tray alert queue selectively displayed by activation of the icon, the system tray alert queue listing the suppressed system tray alerts.

17. The graphical user interface of claim 16 wherein the icon highlights to indicate suppression of a predetermined type of system tray alert.

18. The graphical user interface of claim 17 wherein the predetermined type of system tray alert comprises a modal alert.

19. The graphical user interface of claim 16 wherein the system tray alert queue is operable to:
accept a user selection of a suppressed system tray alert; and
present the selected system tray alert.

20. The graphical user interface of claim 16 further comprising a white list of applications that generate alerts not subject to suppression.
